(19) United States
(12) Patent Application Publication
(10) Pub. No.: US 2026/0267733 A1
(43) Pub. Date: Sep. 10, 2026

(54) DRIVE RECOVERY FROM POWER-DOWN DATA RETENTION

(71) Applicant: Sandisk Technologies, Inc., Milpitas, CA (US)

(72) Inventor: Abigail Biin Drun, Sunnyvale, CA (US)

(21) Appl. No.: 19/072,684

(22) Filed: Mar. 6, 2025

(51) Int. Cl. G06F 11/10

(52) U.S. Cl. CPC G06F 11/1004; G06F 11/0727; G06F 11/076; G06F 11/0793

(57) ABSTRACT

A controller that includes data storage device recovery from a power down condition with respect to data retention. The controller is configured to: select previously programmed blocks that were present prior to a power-off condition, determine a failed bit count (FBC) for the selected previously programmed blocks using read threshold entries from a power-on data retention look-up table, determine whether one or more of the read threshold entries from the power-on data retention look-up table yields zero uncorrectable code words in the selected previously programmed blocks, and, if not, determine whether one or more of the read threshold entries from a power-off data retention look-up table yield the zero uncorrectable code words in the selected previously programmed blocks; a data retention time value will be assigned to the blocks that corresponds to a read threshold entry that yields the least uncorrectable code words and a lowest FBC.

### FIELD

This application relates generally to data storage devices, and more particularly, to a controller that includes data storage device recovery from a power down condition with respect to data retention.

### BACKGROUND

Data storage devices, such as solid-state drives (SSDs), play a crucial role in modern computing systems by providing non-volatile storage for data. These devices typically employ NAND flash memory or other types of non-volatile memory to store data persistently. However, one challenge faced by data storage devices is maintaining data integrity during and after power loss events.

### SUMMARY

When a data storage device experiences an unexpected power loss or is powered down for an extended period, the stored data will degrade over time due to charge leakage in the memory cells. This phenomenon is known as data retention, and it can lead to data corruption or loss if not properly managed. Additionally, data retention time is a temperature-dependent time referring to the duration for which data has been stored since programming.

Conventional data storage devices often implement various techniques to mitigate the effects of data retention, such as periodic refresh operations or error correction coding. However, these approaches may not always be optimal in terms of power consumption, performance, or overall efficiency, especially when recovering from a power-down condition.

Furthermore, the recovery process after a power-down event can be time-consuming and resource-intensive, potentially impacting the device's responsiveness and user experience. This is particularly problematic in scenarios where rapid access to data is critical, such as in enterprise environments or mission-critical applications.

As data storage capacities continue to increase and the reliance on these devices grows, there is a need for improved methods and systems to enhance the efficiency of data storage device recovery from power-down conditions while maintaining data integrity. Addressing these challenges can lead to more reliable, responsive, and energy-efficient data storage solutions.

In some aspects, the disclosure includes a data storage device including: a non-volatile memory device; and a controller coupled to the non-volatile memory device, wherein the controller is configured to: select previously programmed blocks in the non-volatile memory device that were present prior to a power-off condition, determine a failed bit count (FBC) for the selected previously programmed blocks using read threshold entries from a power-on data retention look-up table, determine whether one or more of the read threshold entries from the power-on data retention look-up table yields zero uncorrectable code words in the selected previously programmed blocks, responsive to determining that all of the read threshold entries from the power-on data retention look-up table yield more than the zero uncorrectable code words in the selected previously programmed blocks, determine whether one or more of the read threshold entries from a power-off data retention look-up table yield the zero uncorrectable code words in the selected previously programmed blocks, and responsive to determining that the one or more of the read threshold entries from the power-off data retention look-up table yield the zero uncorrectable code words in the selected previously programmed blocks, assign a data retention time value to all blocks that corresponds to a read threshold entry from the power-off data retention look-up table that yields zero uncorrectable code words and a lowest FBC.

In some aspects, the disclosure includes a method including: selecting, with a controller, previously programmed blocks in a non-volatile memory device that were present prior to a power-off condition; determining, with the controller, a failed bit count (FBC) for the selected previously programmed blocks using read threshold entries from a power-on data retention look-up table; determining, with the controller, whether one or more of the read threshold entries from the power-on data retention look-up table yields zero uncorrectable code words in the selected previously programmed blocks; responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.

In some aspects, the disclosure includes an apparatus including: means for selecting previously programmed blocks in a non-volatile memory device that were present prior to a power-off condition; means for determining a failed bit count (FBC) for the selected previously programmed blocks using read threshold entries from a power-on data retention look-up table; means for determining whether one or more of the read threshold entries from the power-on data retention look-up table yields zero uncorrectable code words in the selected previously programmed blocks; means for responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and means for responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.

In some aspects, the disclosure includes a non-transitory computer-readable medium including instructions that, when executed by an electronic processor, cause the electronic processor to perform a set of operation including: selecting previously programmed blocks in a non-volatile memory device that were present prior to a power-off condition; determining a failed bit count (FBC) for the selected previously programmed blocks using read threshold entries from a power-on data retention look-up table; determining whether one or more of the read threshold entries from the power-on data retention look-up table yields zero uncorrectable code words in the selected previously programmed blocks; responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.

Various aspects of the present disclosure provide for improvements in data storage devices. For example, reducing or mitigating errors associated with data retention over a period of time. The present disclosure can be embodied in various forms, including hardware or circuits controlled by software, firmware, or a combination thereof. The foregoing summary is intended solely to give a general idea of various aspects of the present disclosure and does not limit the scope of the present disclosure in any way.

### BRIEF DESCRIPTION OF THE DRAWINGS

FIG. 1 is a block diagram illustrating an example of a system including a data storage device, according to some embodiments.

FIG. 2 is a graph illustrating voltage threshold distributions for the higher memory states in a non-volatile memory device with quad-level cell (QLC) flash memory, according to some embodiments.

FIG. 3 is a flow chart illustrating a method for modifying data retention time values in the event of an extended power-off condition in a data storage device, according to some embodiments.

FIG. 4 is a table illustrating one example of a power-on data retention look-up table used by the data storage device of FIG. 1, according to some embodiments.

FIG. 5 is a table illustrating one example of a power-off data retention look-up table used by the data storage device of FIG. 1, according to some embodiments.

FIG. 6 is a table illustrating an example improvement in a first sequential read when the data storage device of FIG. 1 uses a power-off data retention look-up table, according to some embodiments.

### DETAILED DESCRIPTION

In the following description, numerous details are set forth, such as data storage device configurations, controller operations, and the like, in order to provide an understanding of one or more aspects of the present disclosure. It will be readily apparent to one skilled in the art that these specific details are merely exemplary and not intended to limit the scope of this application. In particular, the functions associated with the controller can be performed by hardware (for example, analog or digital circuits), a combination of hardware and software (for example, program code or firmware stored in a non-transitory computer-readable medium that is executed by a processor or control circuitry), or any other suitable means. The following description is intended solely to give a general idea of various aspects of the present disclosure and does not limit the scope of the disclosure in any way. Furthermore, it will be apparent to those of skill in the art that, although the present disclosure refers to NAND flash, the concepts discussed herein are applicable to other types of solid-state memory, such as NOR, PCM (“Phase Change Memory”), ReRAM, MRAM, etc.

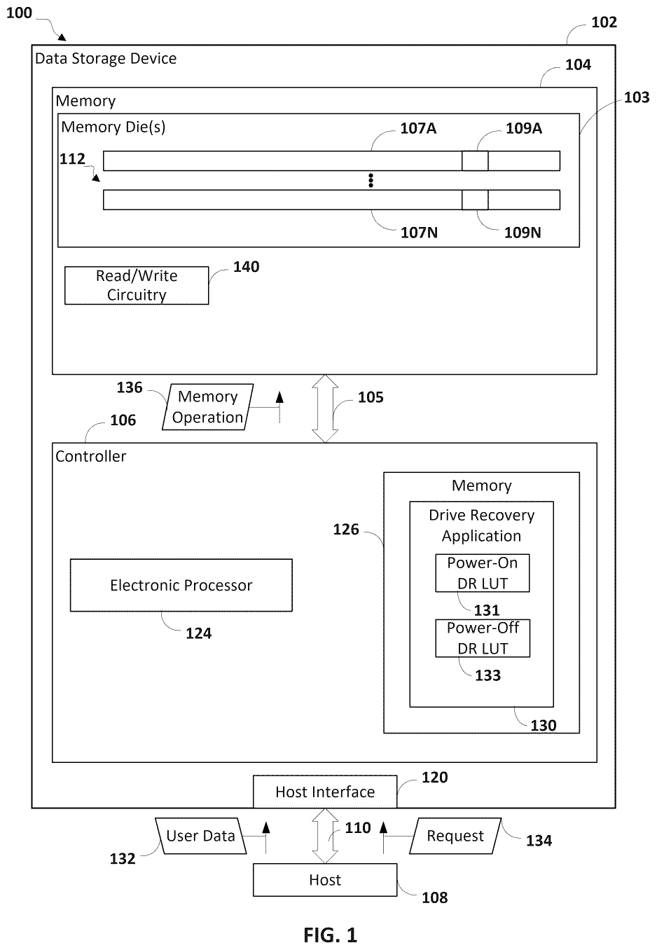

FIG. 1 is a block diagram illustrating an example of a system 100 including a data storage device 102, according to some embodiments of the disclosure. In the example of FIG. 1, the system 100 includes a data storage device 102 in communication with a host device 108. The data storage device 102 includes a memory device 104 (e.g., a non-volatile memory device) that is coupled to a controller 106.

One example of the structural and functional features provided by the controller 106 are illustrated in FIG. 1. However, the controller 106 is not limited to the structural and functional features provided by the controller 106 in FIG. 1. The controller 106 may include fewer or additional structural and functional features that are not illustrated in FIG. 1.

The data storage device 102 and the host device 108 may be operationally coupled via a connection (e.g., a communication path 110), such as a bus or a wireless connection. In some examples, the data storage device 102 may be embedded within the host device 108. Alternatively, in other examples, the data storage device 102 may be removable from the host device 108 (i.e., “removably” coupled to the host device 108). As an example, the data storage device 102 may be removably coupled to the host device 108 in accordance with a removable universal serial bus (USB) configuration. In some implementations, the data storage device 102 may include or correspond to a solid state drive (SSD), which may be used as an embedded storage drive (e.g., a mobile embedded storage drive), an enterprise storage drive (ESD), a client storage device, or a cloud storage drive, or other suitable storage drives.

The data storage device 102 may be configured to be coupled to the host device 108 via the communication path 110, such as a wired communication path and/or a wireless communication path. For example, the data storage device 102 may include an interface 120 (e.g., a host interface) that enables communication via the communication path 110 between the data storage device 102 and the host device 108, such as when the interface 120 is communicatively coupled to the host device 108.

The host device 108 may include a processor and a memory. The memory may be configured to store data and/or instructions that may be executable by the processor. The memory may be a single memory or may include one or more memories, such as one or more non-volatile memories, one or more volatile memories, or a combination thereof. The host device 108 may issue one or more commands to the data storage device 102, such as one or more requests to erase data at, read data from, or write data to the memory device 104 of the data storage device 102. For example, the host device 108 may be configured to provide data, such as user data 132, to be stored at the memory device 104 or to request data to be read from the memory device 104. The host device 108 may include a mobile smartphone, a music player, a video player, a gaming console, an electronic book reader, a personal digital assistant (PDA), a computer, such as a laptop computer or notebook computer, any combination thereof, or other suitable electronic device.

The host device 108 communicates via a memory interface that enables reading from the memory device 104 and writing to the memory device 104. In some examples, the host device 108 may operate in compliance with an industry specification, such as a Universal Flash Storage (UFS) Host Controller Interface specification. In other examples, the host device 108 may operate in compliance with one or more other specifications, such as a Secure Digital (SD) Host Controller specification or other suitable industry specification. The host device 108 may also communicate with the memory device 104 in accordance with any other suitable communication protocol.

The memory device 104 of the data storage device 102 may include a non-volatile memory (e.g., NAND, BiCS family of memories, or other suitable memory). In some examples, the memory device 104 may be any type of flash memory. For example, the memory device 104 may be two-dimensional (2D) memory or three-dimensional (3D) flash memory. The memory device 104 may include one or more memory dies 103. Each of the one or more memory dies 103 may include one or more memory blocks 112 (e.g., one or more erase blocks). Each memory block 112 may include one or more groups of storage elements, such as a representative group of storage elements 107A-107N. The group of storage elements 107A-107N may be configured as a wordline. The group of storage elements 107A-107N may include multiple storage elements (e.g., memory cells that are referred to herein as a “string”), such as a representative storage elements 109A and 109N, respectively. In some examples, the storage elements 107A-107N may be referred to as flash management units (“FMU”). In other examples, an FMU may be equivalent to storage elements 109A and 109N. In one embodiment, an FMU is equivalent to the memory block 112 and may therefore be used interchangeably with the term “memory block.”

The memory device 104 may include support circuitry, such as read/write circuitry 140. Although depicted as a single component, the read/write circuitry 140 may be divided into separate components of the memory device 104, such as read circuitry and write circuitry. The read/write circuitry 140 may be external to the one or more memory dies 103 of the memory device 104. Alternatively, one or more individual memory dies 103 may include corresponding read/write circuitry 140 that is operable to read from and/or write to storage elements within the individual memory die independent of any other read and/or write operations at any of the other memory dies.

The controller 106 is coupled to the memory device 104 (e.g., the one or more memory dies 103) via a bus 105, an interface (e.g., interface circuitry), another structure, or a combination thereof. For example, the bus 105 may include multiple distinct channels to enable the controller 106 to communicate with each of the one or more memory dies 103 in parallel with, and independently of, communication with the other memory dies 103.

The controller 106 is configured to receive data and instructions from the host device 108 and to send data to the host device 108. For example, the controller 106 may send data to the host device 108 via the interface 120, and the controller 106 may receive data (e.g., a request 134) from the host device 108 via the interface 120. The controller 106 is configured to send data and commands (e.g., the memory operation 136, which may be a cycle operation of a memory block of the memory device 104) to the memory device 104 and to receive data from the memory device 104. For example, the controller 106 is configured to send data and a program or write command to cause the memory device 104 to store data to a specified address of the memory device 104. The write command may specify a physical address of a portion of the memory device 104 (e.g., a physical address of a word line of the memory device 104) that is to store the data.

The controller 106 is configured to send a read command to the memory device 104 to access data from a specified address of the memory device 104. The read command may specify the physical address of a region of the memory device 104 (e.g., a physical address of a word line of the memory device 104). The controller 106 may also be configured to send data and commands to the memory device 104 associated with background scanning operations, garbage collection operations, and/or wear-leveling operations, or other suitable memory operations.

The controller 106 may include a processor 124, a memory 126, and other associated circuitry. The memory 126 may be configured to store data and/or instructions that may be executable by the processor 124. The memory 126 may include a drive recovery application 130. The drive recovery application 130 may include one or more data retention look up tables. For example, the drive recovery application 130 may include a power-on data retention (DR) look-up table 131 and a power-off data retention (DR) look-up table 133.

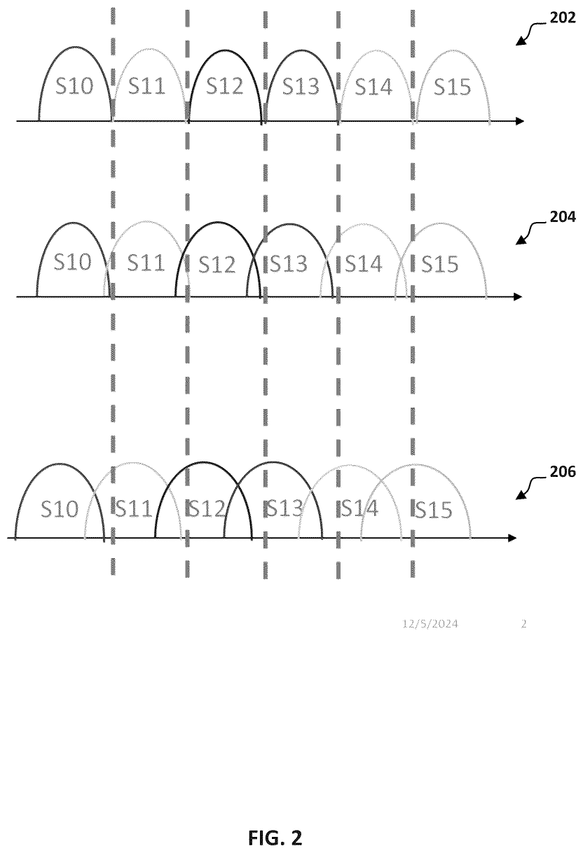

FIG. 2 is a graph illustrating voltage threshold distributions 202-206 for the higher memory states in a non-volatile memory device with quad-level cell (QLC) flash memory, according to some embodiments. FIG. 2 is described with respect to the data storage device 102.

The graph depicts three horizontal axes, each horizontal axis representing a different condition or time point for the memory device. On each axis, six bell-shaped curves labeled S10, S11, S12, S13, S14, and S15 represent different memory states. Vertical dashed lines between each of the states 202-206 indicate the read threshold voltages used to distinguish between adjacent states.

The top axis 202 may represent the initial programmed state of the memory cells, with well-defined and separated voltage distributions for each state. The middle axis 204 may show how these distributions shift and broaden over time due to charge leakage or other factors affecting data retention. The bottom axis 206 may illustrate a more extreme case of distribution shift and broadening, potentially representing the state of the memory after an extended period without power or under adverse conditions.

As the distributions shift and broaden, the overlap between adjacent states increases, which may lead to read errors. The controller 106 may use this information to adjust read threshold voltages dynamically, improving the accuracy of read operations as the memory device ages or experiences different environmental conditions. In some cases, the controller 106 may implement adaptive read algorithms that take into account the current state of the voltage distributions. These algorithms may involve multiple read operations at different threshold voltages to determine the most likely state of each memory cell.

The extent of distribution shift and broadening may vary depending on factors such as the type of memory technology used, the number of program/erase cycles the memory has undergone, and the environmental conditions to which the device has been exposed. For example, higher temperatures may accelerate charge leakage, leading to more rapid shifts in voltage distributions. In some implementations, the controller 106 may maintain a history of environmental conditions and use this information to predict and compensate for expected changes in voltage distributions.

Additionally, the controller 106 may employ error correction techniques to recover data even when there is significant overlap between adjacent state distributions. These techniques may include the use of error-correcting codes (ECC) with varying strengths, depending on the expected error rates for different regions of the memory. In some aspects, the controller 106 may dynamically adjust the strength of error correction based on the observed error rates and the current state of the voltage distributions.

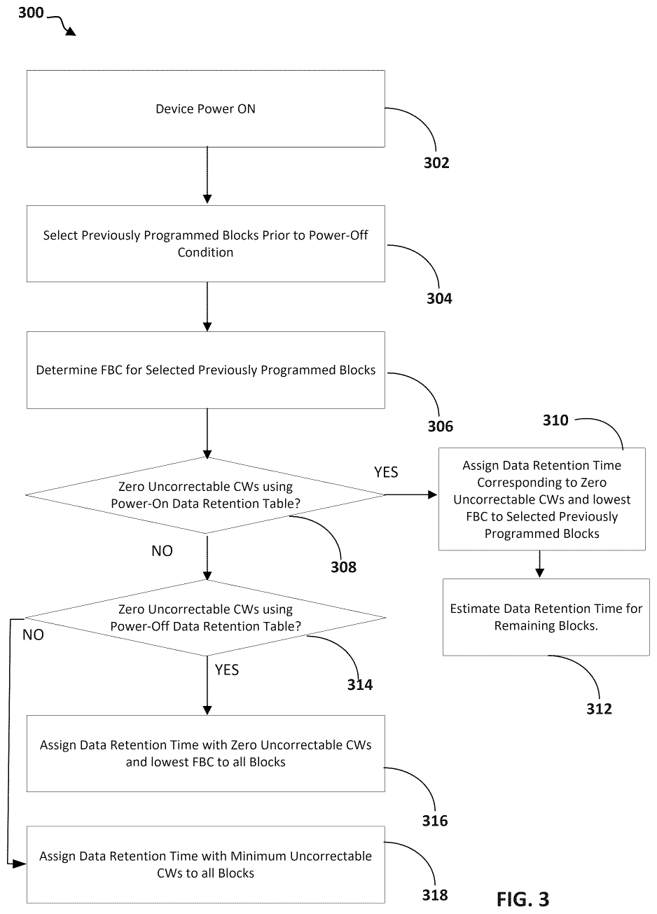

FIG. 3 is a flow chart illustrating a process 300 for modifying data retention time values in the event of an extended power-off condition in a data storage device, according to some embodiments. FIG. 3 is described with respect to the data storage device 102.

In one example, the controller 106 may execute the process 300, such as using the drive recovery application 130. The process 300 begins when the device is powered on (block 302). After powering on, the process 300, such as via the controller 106, selects previously programmed blocks that were present prior to the power-off condition (at block 304). The selection of these blocks may be based on various criteria, such as their location in memory, their age, or their importance to system functionality.

The process 300 further includes determining the failed bit count (FBC) for the selected previously programmed blocks using read threshold entries from a power-on data retention look-up table 131 (at block 306). In some examples, the determining of the FBC may include performing multiple read operations at different voltage thresholds from the power-on data retention look-up table 131 to accurately determine the FBC.

Responsive to determining the FBC, the process 300 determines whether one or more of the read threshold entries from the power-on data retention look-up table 131 yields zero uncorrectable code words (CWs) in the selected previously programmed blocks (at decision block 308). This determination may involve using error correction codes (ECC) to attempt to correct any errors in the selected previously programmed blocks (e.g., in the read data).

In response to determining that the one or more of the read threshold entries from the power-on data retention look-up table yield the zero uncorrectable code words in the selected previously programmed blocks (“YES” at decision block 308), the process 300 includes assigning the data retention (DR) time corresponding to zero uncorrectable CWs and the lowest FBC to the selected previously programmed blocks (at block 310). This data retention time may be obtained from the power-on data retention (DR) look-up table 131.

In some examples, after assigning the DR time corresponding to the zero uncorrectable CWs and lowest FBC to the selected previously programmed blocks, the process 300 may estimate the DR time for the remaining blocks that are distinct from the selected previously programmed blocks (at block 312). This estimation of the DR for the remaining blocks may be based on various factors such as the age of the blocks, their wear level, and environmental conditions.

Additionally, in some examples, in response to determining that all read threshold entries from the power-on data retention look-up table yield more than the zero uncorrectable code words in the selected previously programmed blocks (“NO” at decision block 308), the process 300 includes determining whether one or more of the read threshold entries from the power-off data retention (DR) look-up table 133 yield the zero uncorrectable code words in the selected previously programmed blocks (at decision block 314). This determination may involve a more detailed analysis of the blocks, potentially including multiple read operations at different voltage thresholds.

In some examples, in response to determining that the one or more of the read threshold entries from the power-off data retention look-up table yield the zero uncorrectable code words in the selected previously programmed blocks (“YES” at decision block 314), assign a third data retention time value to all blocks that corresponds to the read threshold entry from the power-off data retention look-up table that yields zero uncorrectable code words and the lowest FBC (at block 316).

In some examples, in response to determining that the one or more of the read threshold entries from the power-off data retention look-up table yield more than the zero uncorrectable code words in the selected previously programmed blocks (“NO” at decision block 314), the process 300 may also include assigning the DR time with minimum uncorrectable CWs to all blocks (at block 318). The application of the DR time with minimum uncorrectable CWs to all blocks may involve adjusting read threshold voltages for all blocks based on the results of various operations of the process 300.

The process 300 may allow the data storage device to adapt its data retention parameters based on the actual condition of the memory after an extended power-off period, which may increase read accuracy and overall device performance. The process 300 may also include additional steps such as logging the results of the process, updating wear leveling information, or initiating background refresh operations for blocks that show signs of significant data degradation.

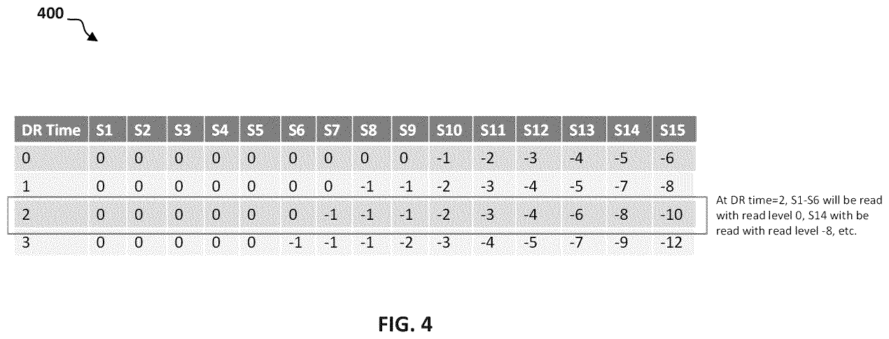

FIG. 4 illustrates one example of a power-on DR look-up table 400 used by the data storage device 102 of FIG. 1, according to some embodiments. The power-on DR look-up table 400 is one example of the power-on DR look-up table 131 of FIG. 1.

The table 400 contains multiple rows and columns of data, with the leftmost column showing DR Time values ranging from 0 to 3. The remaining columns, labeled S1 through S15, contain read threshold offset values corresponding to different states for each DR Time.

The read threshold offset values in the table 400 generally become more negative as the DR Time and state number increase. For example, at DR Time 0, offset values are 0 for read threshold offset values S1-S9, negative one for S10, negative two for S11, negative three for S12, negative four for S13, negative five for S14, and negative six for S15.

At DR Time 1, offset values are 0 for read threshold offset values S1-S7, negative one for S8 and S9, negative two for S10, negative three for S11, negative four for S12, negative five for S13, negative seven for S14, and negative eight for S15.

At DR Time 2, offset values are 0 for read threshold offset values S1-S6, negative one for S7, S8, and S9, negative two for S10, negative three for S11, negative four for S12, negative six for S13, negative eight for S14, and negative ten for S15.

At DR Time 3, offset values are 0 for read threshold offset values S1-S5, negative one for S6, S7, and S8, negative two for S9, negative three for S10, negative four for S11, negative five for S12, negative seven for S13, negative nine for S14, and negative twelve for S15.

Comparing DR Time 3 to DR Time 0, there are less lower numbered states with a 0 offset value and the highest numbered state S15 has offset value of negative 12, which is double the offset value for S15 at DR Time 0. These changes illustrate that significant adjustments are needed for higher states as retention time increases.

This power-on DR look-up table may allow the controller 106 to determine appropriate read threshold offsets based on the current DR Time, enabling optimized reading of data from the non-volatile memory device under various data retention conditions during powered-on operation.

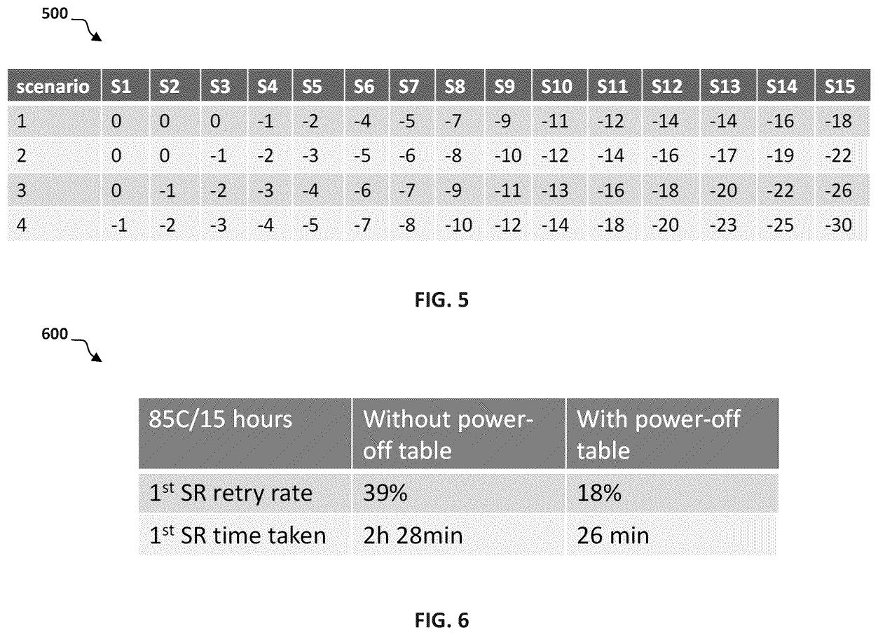

FIG. 5 illustrates one example of a power-off DR lookup table 500 used by the data storage device 102 of FIG. 1, according to some embodiments. The power-off DR look-up table 500 is one example of the power-off DR look-up table 133 of FIG. 1.

The table 500 contains multiple entries for different scenarios, with each row representing a different scenario (1-4) and each column representing a different state (S1-S15). The values in the table represent read threshold offsets that can be applied for each scenario and state combination. Each scenario maps to a specific higher DR time, depending on the user case, and higher number scenarios represent stronger DR.

For example, at DR Time 0, offset values are 0 for read threshold offset values S1-S3, negative one for S4, negative two for S5, negative four for S6, negative five for S7, negative seven for S8, negative nine for S9, negative eleven for S10, negative twelve for S11, negative fourteen for S12 and S13, negative sixteen for S14, and negative eighteen for S15.

At DR Time 1, offset values are 0 for read threshold offset values S1 and S2, negative one for S3, negative two for S4, negative three for S5, negative five for S6, negative six for S7, negative eight for S8, negative ten for S9, negative twelve for S10, negative fourteen for S11, negative sixteen for S12, negative seventeen for S13, negative nineteen for S14, and negative twenty-two for S15.

At DR Time 2, offset values are 0 for read threshold offset value S1, negative one for S2, negative two for S3, negative three for S4, negative four for S5, negative six for S6, negative seven for S7, negative nine for S8, negative eleven for S9, negative thirteen for S10, negative sixteen for S11, negative eighteen for S12, negative twenty for S13, negative twenty-two for S14, and negative twenty-six for S15.

At DR Time 3, offset values are negative one for S1, negative two for S2, negative three for S3, negative four for S4, negative five for S5, negative seven for S6, negative eight for S7, negative ten for S8, negative twelve for S9, negative fourteen for S10, negative eighteen for S11, negative twenty for S12, negative twenty-three for S13, negative twenty-five for S14, and negative thirty for S15.

As illustrated in the table 500, the offset values generally become more negative (larger absolute values) for higher numbered states and scenarios over a longer DR time, indicating increasingly aggressive read threshold adjustments may be needed for longer power-off durations or more extreme conditions. The offset values in the table 500 are also more negative than the offset values in the table 400.

This power-off DR lookup table 500 may allow the controller 106 to select appropriate read threshold offsets based on the estimated power-off duration and conditions when the data storage device is powered back on after an extended power-off period. By applying the offset values in the power-off DR lookup table 500, the controller 106 may increase the accuracy of read operations and reduce the likelihood of uncorrectable errors when recovering data after power is restored.

FIG. 6 is a table illustrating an example improvement 600 in a first sequential read when a data storage device uses a power-off data retention look-up table, according to some embodiments. With respect to the example improvement 600, after a data storage device is subjected to 85 degrees Celsius power-off data retention for fifteen hours, the first sequential read retry rate without a power-off DR lookup table is 39% and takes two hours and twenty-eight minutes. Comparatively, with respect to the example improvement 600, the first sequential read retry rate with the power-off DR lookup table is 18% and takes twenty-six minutes. In other words, the retry rate is cut in half and the first sequential read is 5× faster.

The following are enumerated devices, methods, and non-transitory computer-readable media of the present disclosure. Example 1: a data storage device comprising: a non-volatile memory device; and a controller coupled to the non-volatile memory device, wherein the controller is configured to: select previously programmed blocks in the non-volatile memory device that were present prior to a power-off condition, determine a failed bit count (FBC) for the selected previously programmed blocks using read threshold entries from a power-on data retention look-up table, determine whether one or more of the read threshold entries from the power-on data retention look-up table yields zero uncorrectable code words in the selected previously programmed blocks, responsive to determining that all of the read threshold entries from the power-on data retention look-up table yield more than the zero uncorrectable code words in the selected previously programmed blocks, determine whether one or more of the read threshold entries from a power-off data retention look-up table yield the zero uncorrectable code words in the selected previously programmed blocks, and responsive to determining that the one or more of the read threshold entries from the power-off data retention look-up table yield the zero uncorrectable code words in the selected previously programmed blocks, assign a data retention time value to all blocks that corresponds to a read threshold entry from the power-off data retention look-up table that yields zero uncorrectable code words and a lowest FBC.
Example 2: the data storage device of Example 1, wherein the controller is further configured to: estimate a second data retention time for remaining blocks in the non-volatile memory device using the data retention time of the selected previously programmed blocks, the remaining blocks are distinct from the selected previously programmed blocks.
Example 3: the data storage device of Examples 1 or 2, wherein the controller is further configured to: responsive to determining that the one or more of the read threshold entries from the power-on data retention look-up table yield the zero uncorrectable code words in the selected previously programmed blocks, assign a data retention time to the selected previously programmed blocks, the data retention time from the power-on data retention look-up table yielding the zero uncorrectable code words and the lowest FBC.
Example 4: the data storage device of any of Examples 1-3, wherein the controller is further configured to: responsive to determining that the one or more of the read threshold entries from the power-off data retention look-up table yield more than the zero uncorrectable code words in the selected previously programmed blocks, apply a fourth data retention time to all blocks that corresponds to a lowest number of uncorrectable code words in the selected previously programmed blocks.
Example 5: the data storage device of any of Examples 1-4, wherein the power-off data retention look-up table includes a plurality of read threshold offset values for each different memory state and power-off scenario.
Example 6: the data storage device of any of Examples 1-5, wherein the power-on data retention look-up table includes a plurality of read threshold offset values for each different memory state and data retention time.
Example 7: a method comprising: selecting, with a controller, previously programmed blocks in a non-volatile memory device that were present prior to a power-off condition; determining, with the controller, a failed bit count (FBC) for the selected previously programmed blocks using read threshold entries from a power-on data retention look-up table; determining, with the controller, whether one or more of the read threshold entries from the power-on data retention look-up table yields zero uncorrectable code words in the selected previously programmed blocks; responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.
Example 8: the method of Example 7, further comprising: estimating a second data retention time for remaining blocks in the non-volatile memory device using the data retention time of the selected previously programmed blocks, the remaining blocks are distinct from the selected previously programmed blocks.
Example 9: the method of Examples 7 or 8, further comprising: responsive to determining that the one or more of the read threshold entries from the power-on data retention look-up table yields zero uncorrectable code words in the selected previously programmed blocks, assigning, with the controller, a data retention time to the selected previously programmed blocks that corresponds to the data retention time from the power-on data retention look-up table yielding the zero uncorrectable code words and the lowest FBC.
Example 10: the method of any of Examples 7-9, further comprising: responsive to determining that the one or more of the read threshold entries from the power-off data retention look-up table yield more than the zero uncorrectable code words in the selected previously programmed blocks, applying a fourth data retention time to all blocks that corresponds to a lowest number of uncorrectable code words in the selected previously programmed blocks.
Example 11: the method of any of Examples 7-10, wherein the power-off data retention look-up table includes a plurality of read threshold offset values for each different memory state and power-off scenario.
Example 12: the method of any of Examples 7-11, wherein the power-on data retention look-up table includes a plurality of read threshold offset values for each different memory state and data retention time.
Example 13: an apparatus comprising: means for selecting previously programmed blocks in a non-volatile memory device that were present prior to a power-off condition; means for determining a failed bit count (FBC) for the selected previously programmed blocks using read threshold entries from a power-on data retention look-up table; means for determining whether one or more of the read threshold entries from the power-on data retention look-up table yields zero uncorrectable code words in the selected previously programmed blocks; means for responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and means for responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.
Example 14: the apparatus of Example 13, further comprising: means for estimating a second data retention time for remaining blocks in the non-volatile memory device using the data retention time of the selected previously programmed blocks, the remaining blocks are distinct from the selected previously programmed blocks.
Example 15: the apparatus of Examples 13 or 14, further comprising: means for responsive to determining that the one or more of the read threshold entries from the power-on data retention look-up table yields zero uncorrectable code words in the selected previously programmed blocks, assigning a data retention time to the selected previously programmed blocks, the data retention time from the power-on data retention look-up table yielding the zero uncorrectable code words and the lowest FBC.
Example 16: the apparatus of any of Examples 13-15, further comprising: means for responsive to determining that the one or more of the read threshold entries from the power-off data retention look-up table yield more than the zero uncorrectable code words in the selected previously programmed blocks, applying a fourth data retention time to all blocks that corresponds to a lowest number of uncorrectable code words in the selected previously programmed blocks.
Example 17: the apparatus of any of Examples 13-16, wherein the power-off data retention look-up table includes a plurality of read threshold offset values for each different memory state and power-off scenario.
Example 18: the apparatus of any of Examples 13-17, wherein the power-on data retention look-up table includes a plurality of read threshold offset values for each different memory state and data retention time.
Example 19: a non-transitory computer-readable medium comprising instructions that, when executed by an electronic processor, cause the electronic processor to perform a set of operation comprising: selecting previously programmed blocks in a non-volatile memory device that were present prior to a power-off condition; determining a failed bit count (FBC) for the selected previously programmed blocks using read threshold entries from a power-on data retention look-up table; determining whether one or more of the read threshold entries from the power-on data retention look-up table yields zero uncorrectable code words in the selected previously programmed blocks; responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.
Example 20: the non-transitory computer-readable medium of Example 19, wherein the set of operation further includes estimating a second data retention time for remaining blocks in the non-volatile memory device using the data retention time of the selected previously programmed blocks, the remaining blocks are distinct from the selected previously programmed blocks.
Example 21: the non-transitory computer-readable medium of Examples 19 or 20, wherein the set of operation further includes responsive to determining that the one or more of the read threshold entries from the power-on data retention look-up table yields zero uncorrectable code words in the selected previously programmed blocks, assigning a data retention time to the selected previously programmed blocks, the data retention time from the power-on data retention look-up table yielding the zero uncorrectable code words and the lowest FBC.
Example 22: the non-transitory computer-readable medium of any of Examples 19-21, wherein the set of operation further includes responsive to determining that the one or more of the read threshold entries from the power-off data retention look-up table yield more than the zero uncorrectable code words in the selected previously programmed blocks, applying a fourth data retention time to all blocks that corresponds to a lowest number of uncorrectable code words in the selected previously programmed blocks.
Example 23: the non-transitory computer-readable medium of any of Examples 19-22, wherein the power-off data retention look-up table includes a plurality of read threshold offset values for each different memory state and power-off scenario.
Example 24: the non-transitory computer-readable medium of any of Examples 19-23, wherein the power-on data retention look-up table includes a plurality of read threshold offset values for each different memory state and data retention time.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A data storage device comprising:
a non-volatile memory device; and
a controller coupled to the non-volatile memory device, wherein the controller is configured to:
select previously programmed blocks in the non-volatile memory device that were present prior to a power-off condition,
determine a failed bit count (FBC) for the selected previously programmed blocks using read threshold entries from a power-on data retention look-up table,
determine whether one or more of the read threshold entries from the power-on data retention look-up table yields zero uncorrectable code words in the selected previously programmed blocks,
responsive to determining that all of the read threshold entries from the power-on data retention look-up table yield more than the zero uncorrectable code words in the selected previously programmed blocks, determine whether one or more of the read threshold entries from a power-off data retention look-up table yield the zero uncorrectable code words in the selected previously programmed blocks, and
responsive to determining that the one or more of the read threshold entries from the power-off data retention look-up table yield the zero uncorrectable code words in the selected previously programmed blocks, assign a data retention time value to all blocks that corresponds to a read threshold entry from the power-off data retention look-up table that yields zero uncorrectable code words and a lowest FBC.

2. The data storage device of claim 1, wherein the controller is further configured to:
estimate a second data retention time for remaining blocks in the non-volatile memory device using the data retention time of the selected previously programmed blocks, the remaining blocks are distinct from the selected previously programmed blocks.

3. The data storage device of claim 1, wherein the controller is further configured to:
responsive to determining that the one or more of the read threshold entries from the power-on data retention look-up table yield the zero uncorrectable code words in the selected previously programmed blocks, assign a data retention time to the selected previously programmed blocks, the data retention time from the power-on data retention look-up table yielding the zero uncorrectable code words and the lowest FBC.

4. The data storage device of claim 1, wherein the controller is further configured to:
responsive to determining that the one or more of the read threshold entries from the power-off data retention look-up table yield more than the zero uncorrectable code words in the selected previously programmed blocks, apply a fourth data retention time to all blocks that corresponds to a lowest number of uncorrectable code words in the selected previously programmed blocks.

5. The data storage device of claim 1, wherein the power-off data retention look-up table includes a plurality of read threshold offset values for each different memory state and power-off scenario.

6. The data storage device of claim 1, wherein the power-on data retention look-up table includes a plurality of read threshold offset values for each different memory state and data retention time.

7. A method comprising:
selecting, with a controller, previously programmed blocks in a non-volatile memory device that were present prior to a power-off condition;
determining, with the controller, a failed bit count (FBC) for the selected previously programmed blocks using read threshold entries from a power-on data retention look-up table;
determining, with the controller, whether one or more of the read threshold entries from the power-on data retention look-up table yields zero uncorrectable code words in the selected previously programmed blocks;
responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and
responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.

8. The method of claim 7, further comprising:
estimating a second data retention time for remaining blocks in the non-volatile memory device using the data retention time of the selected previously programmed blocks, the remaining blocks are distinct from the selected previously programmed blocks.

9. The method of claim 7, further comprising:
responsive to determining that the one or more of the read threshold entries from the power-on data retention look-up table yields zero uncorrectable code words in the selected previously programmed blocks, assigning, with the controller, a data retention time to the selected previously programmed blocks that corresponds to the data retention time from the power-on data retention look-up table yielding the zero uncorrectable code words and the lowest FBC.

10. The method of claim 7, further comprising:
responsive to determining that the one or more of the read threshold entries from the power-off data retention look-up table yield more than the zero uncorrectable code words in the selected previously programmed blocks, applying a fourth data retention time to all blocks that corresponds to a lowest number of uncorrectable code words in the selected previously programmed blocks.

11. The method of claim 7, wherein the power-off data retention look-up table includes a plurality of read threshold offset values for each different memory state and power-off scenario.

12. The method of claim 7, wherein the power-on data retention look-up table includes a plurality of read threshold offset values for each different memory state and data retention time.

13. An apparatus comprising:
means for selecting previously programmed blocks in a non-volatile memory device that were present prior to a power-off condition;
means for determining a failed bit count (FBC) for the selected previously programmed blocks using read threshold entries from a power-on data retention look-up table;
means for determining whether one or more of the read threshold entries from the power-on data retention look-up table yields zero uncorrectable code words in the selected previously programmed blocks;
means for responsive to determining that all of the read threshold entries from the power-on data retention look-up table yield more than the zero uncorrectable code words in the selected previously programmed blocks, determining whether one or more of the read threshold entries from a power-off data retention look-up table yield the zero uncorrectable code words in the selected previously programmed blocks; and
means for responsive to determining that the one or more of the read threshold entries from the power-off data retention look-up table yield the zero uncorrectable code words in the selected previously programmed blocks, assigning a third data retention time value to all blocks that corresponds to a read threshold entry from the power-off data retention look-up table that yields zero uncorrectable code words and a lowest FBC.

14. The apparatus of claim 13, further comprising:
means for estimating a second data retention time for remaining blocks in the non-volatile memory device using the data retention time of the selected previously programmed blocks, the remaining blocks are distinct from the selected previously programmed blocks.

15. The apparatus of claim 13, further comprising:
means for responsive to determining that the one or more of the read threshold entries from the power-on data retention look-up table yields zero uncorrectable code words in the selected previously programmed blocks, assigning a data retention time to the selected previously programmed blocks, the data retention time from the power-on data retention look-up table yielding the zero uncorrectable code words and the lowest FBC.

16. The apparatus of claim 13, further comprising:
means for responsive to determining that the one or more of the read threshold entries from the power-off data retention look-up table yield more than the zero uncorrectable code words in the selected previously programmed blocks, applying a fourth data retention time to all blocks that corresponds to a lowest number of uncorrectable code words in the selected previously programmed blocks.

17. The apparatus of claim 13, wherein the power-off data retention look-up table includes a plurality of read threshold offset values for each different memory state and power-off scenario.

18. The apparatus of claim 13, wherein the power-on data retention look-up table includes a plurality of read threshold offset values for each different memory state and data retention time.
